(19) United States
(12) Patent Application Publication
(10) Pub. No.: US 2026/0225002 A1
(43) Pub. Date: Aug. 6, 2026

(54) COMPONENT SEPARATION SYSTEM

(71) Applicant: KABUSHIKI KAISHA TOYOTA CHOU KENKYUSHO, Nagakute-Shi, Aichi (JP)

(72) Inventors: Tsukasa USUKI, Nagakute-Shi (JP); Hirotaka OKAMOTO, Nagakute-Shi (JP); Takayuki HIRAI, Nagakute-Shi (JP)

(73) Assignee: KABUSHIKI KAISHA TOYOTA CHOU KENKYUSHO, Nagakute-Shi, Aichi (JP)

(21) Appl. No.: 19/152,107

(22) PCT Filed: Dec. 27, 2023
(86) PCT No.: PCT/JP2023/047083

§ 371 Date: Jul. 30, 2025

(30) Foreign Application Priority Data
Feb. 3, 2023 (JP) 2023-015498
Oct. 26, 2023 (JP) 2023-184258

(51) Int. Cl. B01D 17/04; B01D 11/04; C08J 11/08

(52) U.S. Cl. CPC B01D 17/042; B01D 11/0492; C08J 11/08; C08J 2323/06; C08J 2323/12; C08J 2325/06

(57) ABSTRACT

A component separation system, including: a first separation unit configured to: add a component C to a one-phase mixed component αβ containing a component A and a component B; and separate a mixed component αβγ containing the component A, the component B, and the component C, at a temperature T₁, into a separated component αγ containing the component A and the component C as a main component and a separated component β containing the component B as a main component; and a second separation unit configured to change a temperature of the separated component αγ to a temperature T₂ to separate the separated component αγ into a separated component α containing the component A as a main component and a separated component γ containing the component C as a main component.

### TECHNICAL FIELD

The present disclosure relates to a component separation system.

### BACKGROUND ART

In recent years, there has come to be a demand for reuse in order to reduce the environmental load, and various techniques for separating components have been studied.

For example, Patent Document 1 discloses that “A method for purifying a reclaimed polypropylene is disclosed. In one embodiment, the method involves obtaining reclaimed polypropylene, contacting the reclaimed polypropylene with a first fluid solvent to produce an extracted reclaimed polypropylene; then dissolving the extracted reclaimed polypropylene in a solvent to produce a first solution comprising polypropylene. The first solution is settled and then filtered. A purer polypropylene is separated from the resulting solution.”.

In addition, Patent Document 2 discloses a “method for reducing a volume of expanded polystyrene, comprising: dissolving expanded polystyrene in a dissolution solvent selected from the group consisting of glycol ether acetate compounds, glycol ether compounds, acetylacetone, diethyl carbonate, and ethyl orthoformate”.
Patent Document 1: Japanese National-Phase Publication (JP-A) No. 2021-526575
Patent Document 2: Japanese Patent Application Laid-Open (JP-A) No. H11-80418

### SUMMARY OF INVENTION

### Technical Problem

In Patent Document 1, high purity reclaimed polypropylene is obtained by dissolving recovered polypropylene in a low boiling point solvent under high pressure conditions and separating the polypropylene from impurities. By reducing the pressure after the removal of impurities, the low boiling point solvent can be easily separated from polypropylene.

However, the method of Patent Document 1 requires processing under high pressure conditions, which leads to an increase in equipment cost. In addition, since the solvent after use is easily vaporized under normal pressure, recovery or reuse of the solvent becomes difficult. In order to reduce the recycling cost, there is a need for a method that can be carried out under normal pressure and can efficiently recover and reuse the solvent.

On the other hand, in Patent Document 2, the volume of polystyrene can be reduced by dissolving the polystyrene in a good solvent, and the polystyrene can be reused by reprecipitating the polystyrene with a poor solvent. In addition, in Patent Document 2, a mixed solvent remaining after reprecipitation is separated by distillation and reused.

However, although the distillation method employed in Patent Document 2 is often used as a component separation method in a mixed solvent, it is known that the cost incurred for heating is large. A method for separating the mixed solvent after reprecipitation at low cost is required.

Therefore, an object of the disclosure is to provide a component separation system capable of carrying out component separation with energy saving under normal pressure without using distillation.

### Solution to Problem

Means to solve the above-described problems include the following embodiments.
<1>A component separation system, comprising:
a first separation unit configured to: add a component C to a one-phase mixed component αβ containing a component A and a component B; and separate a mixed component αβγ containing the component A, the component B, and the component C, at a temperature T₁, into a separated component αγ containing the component A and the component C as a main component and a separated component β containing the component B as a main component; and
a second separation unit configured to change a temperature of the separated component αγ to a temperature T₂ to separate the separated component αγ into a separated component α containing the component A as a main component and a separated component γ containing the component C as a main component,
wherein the component C exhibits a miscible behavior with respect to the component A at the temperature T₁ of the mixed component αβγ, exhibits a separation behavior with respect to the component B at the temperature T₁ of the mixed component αβγ, and exhibits a separation behavior with respect to the component A at the temperature T₂ of the separated component αγ.
<2> The component separation system according to <1>, wherein the first separation unit is a separation unit configured to: add the component C, as an extractant for the component A, to the mixed component αβ, in which the component A in a liquid state and the component B in a liquid state are uniformly mixed, to extract the component A with the component C; and carry out liquid-liquid separation of the separated component αγ and the separated component B.
<3>The component separation system according to <2>, wherein the mixed component αβ is a mixed system after reprecipitation of a solid substance, and is a mixed component in which the component A as a poor solvent for the solid substance and the component B as a good solvent for the solid substance are uniformly mixed.
<4>The component separation system according to <3>, wherein:
the solid substance is a styrene resin,
the component A is an alcohol,
the component B is a terpene, and
the component C is ethylene carbonate.
<5>The component separation system according to <1>, wherein the first separation unit is a separation unit configured to: add the component C in a liquid state, as a poor solvent for the component B, to the mixed component αβ, in which the component B in a solid state is dissolved in the component A in a liquid state that is a good solvent for the component B, to precipitate the component B; and carry out solid-liquid separation of the separated component αγ and the separated component β.
<6>The component separation system according to <5>, wherein:
the component A is an aromatic hydrocarbon,
the component B is a polyolefin resin, and
the component C is ethylene carbonate.
<7>The component separation system according to any one of <2>to <6>, wherein the temperature T₂ is adjusted based on a proportion of the component A or the component C in the separated component αγ.

<8>The component separation system according to any one of <2>to <6>, wherein the temperature T₂ is adjusted based on a composition of the component A or the component C in the separated component αγ.
<9>The component separation system according to <8>, wherein:
the component A is at least one selected from the group consisting of aromatic hydrocarbons and alcohols,
the component B is a polyolefin resin, and
the component C contains ethylene carbonate.
<10>The component separation system according to <9>, wherein the component A is two aromatic hydrocarbons or two alcohols.
<11>The component separation system according to <9>or <10>, wherein the component C is ethylene carbonate and at least one selected from the group consisting of cyclic carbonates, other than ethylene carbonate, and polyhydric alcohols.

### Advantageous Effects of Invention

According to the disclosure, a component separation system capable of carrying out component separation with energy saving under normal pressure without using distillation can be provided.

### BRIEF DESCRIPTION OF DRAWINGS

FIG. 1 is a block diagram illustrating an example of a component separation system of the disclosure.

FIG. 2 is miscible behavior and phase separation behavior diagrams in a composition of a two-component system.

FIG. 3 is a block diagram illustrating an example of a first separation unit according to a first embodiment of the disclosure.

FIG. 4 is a block diagram illustrating another example of the first separation unit according to the first embodiment of the disclosure.

FIG. 5 is a block diagram illustrating an example of a first separation unit according to a second embodiment of the disclosure.

FIG. 6 is a block diagram illustrating another example of the first separation unit according to the second embodiment of the disclosure.

FIG. 7 is a block diagram illustrating an example of a second separation unit according to the embodiment of the disclosure.

FIG. 8 is a block diagram illustrating another example of the second separation unit according to the embodiment of the disclosure.

FIG. 9 is a block diagram illustrating an example of a purification system of a solid substance according to the first embodiment of the disclosure.

FIG. 10 is a block diagram illustrating an example of a purification system of a solid substance according to the second embodiment of the disclosure.

FIG. 11 is a table illustrating solubility of a polystyrene resin in an ethanol-limonene mixed solvent.

FIG. 12 is a diagram illustrating a consumed energy calculation result of the component separation system. FIG. 12(A) is a diagram illustrating a calculation result of a component separation system of Example 1, and FIG. 12(B) is a diagram illustrating a result of the component separation system according to a conventional distillation method.

FIG. 13 is a liquid-liquid equilibrium state diagram of an ethylene carbonate-xylene system.

FIG. 14 is a table illustrating solubility of a polypropylene resin in an ethylene carbonate-xylene mixed solvent.

FIG. 15 is a diagram illustrating a consumed energy calculation result of the component separation system. FIG. 15(A) is a diagram illustrating a calculation result of a component separation system of Example 2, and FIG. 15(B) is a diagram illustrating a result of the component separation system according to a conventional distillation method.

FIG. 16 is a table illustrating solubility of a polyethylene resin in an ethylene carbonate-xylene mixed solvent.

FIG. 17 is a diagram illustrating a consumed energy calculation result of the component separation system. FIG. 17(A) is a diagram illustrating a calculation result of a component separation system of Example 3, and FIG. 17(B) is a diagram illustrating a result of the component separation system according to a conventional distillation method.

FIG. 18 is a diagram illustrating a phase change temperature of a (toluene+xylene)-ethylene carbonate system.

FIG. 19 is a diagram illustrating a phase change temperature of an (ethanol+1-propanol)-ethylene carbonate system.

FIG. 20 is a diagram illustrating a phase change temperature of a xylene-(ethylene carbonate+propylene carbonate) system.

FIG. 21 is a diagram illustrating a phase change temperature of a p-cymene-(ethylene carbonate +propylene carbonate) system.

FIG. 22 is a diagram illustrating a phase change temperature of a xylene-(ethylene carbonate+ethylene glycol) system.

FIG. 23 is a diagram illustrating the consumed energy calculation result of the component separation system. FIG. 23(a) is a diagram illustrating the calculation result of the component separation system of Example 2, and FIG. 23(b) is a diagram illustrating the result of a component separation system of Example 4.

### DESCRIPTION OF EMBODIMENTS

Hereinafter, embodiments of the disclosure will be described. These descriptions and examples illustrate embodiments and do not limit the scope of the invention.

In the numerical ranges described in stages in the present specification, the upper limit value or the lower limit value stated in one numerical range may be replaced with the upper limit value or the lower limit value of another numerical range described in stages. In addition, in the numerical range stated in the present specification, the upper limit value or the lower limit value of a numerical range may be replaced with a value shown in examples.

In the present specification, each component may contain a plurality of corresponding substances.

In addition, when referring to the amount of each component in the composition, if there are a plurality of substances corresponding to each component in the composition, it means the total amount of the plurality of substances present in the composition unless otherwise specified.

In addition, “normal temperature” means 25° C., and “normal pressure” means 1 atm.

### Component Separation System (or Component Separation Method)

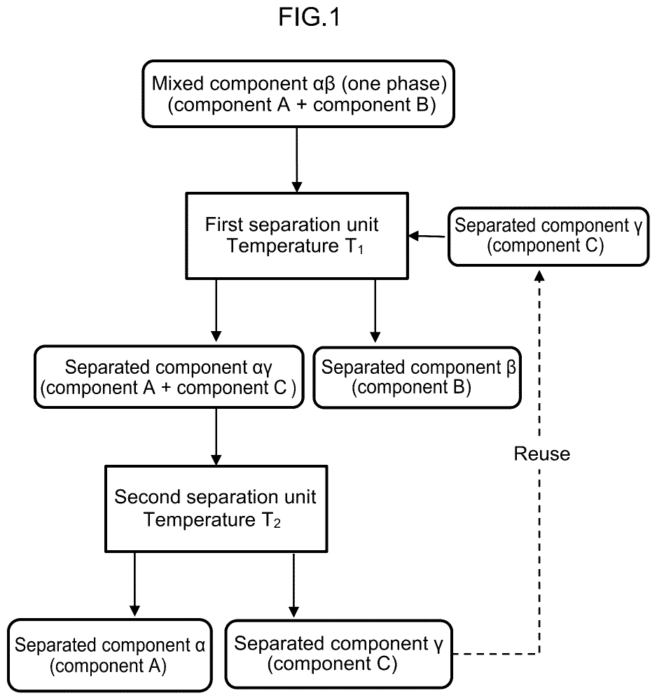

As illustrated in FIG. 1, a component separation method (or a component separation method, the same applies hereinafter) according to the present embodiment includes:
a first separation unit (or a first separation process) configured to: add a component C to a one-phase mixed component αβ containing a component A and a component B; and separate a mixed component αβγ containing the component A, the component B, and the component C, at a temperature T₁, into a separated component αγ containing the component A and the component C as a main component and a separated component β containing the component B as a main component; and
a second separation unit (second separation unit) configured to change the temperature of the separated component αγ to a temperature T₂ to separate the separated component αγ into a separated component α containing the component A as a main component and a separated component γ containing the component C as a main component.

As illustrated in FIG. 1, the separated component γ may be reused as the component C in the first separation unit (or the first separation process).

Further, the component C exhibits a miscible behavior with respect to the component A at the temperature T₁ of the mixed component αβγ, exhibits a separation behavior with respect to the component B (specifically, in a case where the component B is a liquid, the component B is phase separative, or in a case where the component B is a solid, the component B is insoluble) at the temperature T₁ of the mixed component αβγ, and exhibits a separation behavior with respect to the component A at the temperature T₂ of the separated component αγ.

In other words, the component A exhibits a miscible behavior with respect to the component C at the temperature T₁ of the mixed component αβγ, and exhibits a separation behavior with respect to the component C at the temperature T₂ of the separated component αγ.

On the other hand, the component B exhibits a separation behavior with respect to the component C at the temperature T₁ of the mixed component αβγ.

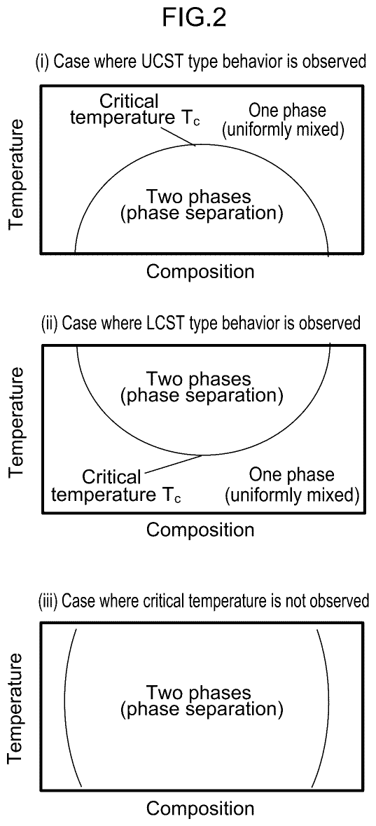

Here, as illustrated in FIG. 2, the miscible behavior and the phase separation behavior in the composition of the two-component system are classified into behaviors such as (i) a case where an upper critical solution temperature (UCST) type behavior is observed, (ii) a case where a lower critical solution temperature (LCST) type behavior is observed, and (iii) a case where critical temperature is not observed.

The behavior of the composition of the two-component system including the component A and the component C corresponds to the behavior of (i) or (ii), and the behavior of the composition of the two-component system including the component B and the component C corresponds to the behavior of (iii).

As described above, in the component separation system according to the present embodiment, by using the component C that exhibits a separation behavior for the component B and a temperature-dependent separation behavior for the component A, the component B can be separated from the mixed component αβ and the component A can be separated from the separated component αγ under normal pressure. That is, by using equilibrium shift of the component A and the component C, a series of separation operations can be carried out under normal pressure, and each component can be separated without distillation.

Therefore, the component separation system according to the present embodiment can carry out component separation with energy saving without using distillation under normal pressure.

Here, the “mixed component αγ containing the component A and the component C as a main component” indicates a mixed system containing the component A and the component C in an amount of 51 mass % or more with respect to the entire separated component αγ.

The “component α containing the component A as a main component” indicates a component containing the component A in an amount of 51 mass % or more with respect to the entire component α.

The “separated component β containing the component B as a main component” indicates a separated component containing the component B in an amount of 51 mass % or more with respect to the entire separated component β.

The “separated component γ containing the component C as a main component” indicates a separated component containing the component C in an amount of 51 mass % or more with respect to the entire separated component γ.

That is, “the component C exhibits a miscible behavior with respect to the component A at the temperature T₁ of the mixed component αβγ and exhibits a separation behavior with respect to the component B at the temperature T₁ of the mixed component αβγ” means that the mixed component αβγ is separated into a separated component αγ in which a total proportion of the component A and the component C to the entire separated component αγ is 51 mass % or more and a separated component γ in which a proportion of the component B to the entire separated component β is 51 mass % or more.

Also, “the component C exhibits a separation behavior with respect to the component A at the temperature T₂ of the separated component αγ” means that the separated component αγ is separated into a separated component α in which the proportion of the component A to the entire separated component α is 51 mass % or more, and a separated component γ in which the proportion of the component C to the entire separated component γ is 51 mass % or more.

As the component A, a liquid component is applied. In a case where the component A is solid at normal temperature, it may be liquefied by heating and used.

Examples of the component A include aromatic hydrocarbons, alcohols, esters, carbonates, ethers, ketones, halogenated hydrocarbons, amides, and sulfoxides.

Examples of the aromatic hydrocarbons include benzene, ethylbenzene, toluene, xylene, mesitylene, cymene, cumene, and pseudocumene.

Examples of the alcohols include aliphatic alcohols (methanol, ethanol, propanol, butanol, hexanol, and the like), and aromatic alcohols (benzyl alcohol and the like).

Examples of the esters include aliphatic carboxylic acid esters (methyl acetate, ethyl acetate, butyl acetate, vinyl acetate, ethyl propionate, ethyl butyrate, and the like).

Examples of the carbonates include chain carbonates (dimethyl carbonate, diethyl carbonate, ethyl methyl carbonate, methyl propyl carbonate, ethyl propyl carbonate, dipropyl carbonate, and the like) and cyclic carbonates (propylene carbonate, ethylene carbonate, butylene carbonate, and the like).

Examples of the ethers include chain ethers (diethyl ether, ethyl propyl ether, ethyl isopropyl ether, and the like) and cyclic ethers (tetrahydrofuran, 2-methyltetrahydrofuran, tetrahydropyran, and the like).

Examples of the ketones include acetone, methyl ethyl ketone, pentanone, hexanone, heptanone, and cyclohexanon.

Examples of the halogenated hydrocarbons include dichloroethane and trichloromethane.

Examples of the amides include N-methyl-2-pyrrolidone and N,N-dimethylformamide.

Examples of the sulfoxides include dimethyl sulfoxide.

As the component B, liquid and solid components can be applied. In a case where the component B is solid at normal temperature, it may be liquefied by heating and used.

Examples of the liquid component B include terpenes (terpene hydrocarbons such as myrcene, limonene, pinene, camphor, sabinene, phellandrene, paracymene, ocimene, terpinene, carene, zingiberene, caryophyllene, bisabolene and cedrene; terpene aldehydes such as citronellal, citral, cyclocitral, safranal, phellandral, perillaldehyde, geranial, neral; and terpene ketones such as camphor and thujone).

Examples of the solid component B include polyolefin resins (polymers such as polypropylene, polyethylene, and cycloolefins), polystyrene resins, and rubbers (ethylene propylene rubber and the like).

As the component C, a liquid component is applied. In a case where the component C is solid at normal temperature, it may be liquefied by heating and used.

Examples of the component C include carbonates, polyhydric alcohols, and water.

Examples of the carbonates include those described above for the component A.

Examples of the polyhydric alcohols include ethylene glycol, propylene glycol, butanediol, diethylene glycol, dipropylene glycol, and glycerin.

Among them, the component C is preferably at least one selected from the group consisting of cyclic carbonates and polyhydric alcohols, preferably at least two selected from the group consisting of cyclic carbonates and polyhydric alcohols, further preferably ethylene carbonate and at least one selected from the group consisting of cyclic carbonates, other than ethylene carbonate, and polyhydric alcohols, and particularly preferably ethylene carbonate and at least one selected from the group consisting of propylene carbonate and ethylene glycol, from the viewpoint of separability and ease of adjustment of T₂.

In particular, ethylene carbonate has a highly symmetric molecular structure, has strong intermolecular interaction, and causes phase change of uniform mixing and separation at a relatively high temperature in a mixed system. Due to the nature of ethylene carbonate, each component can be easily separated by a mild cooling operation in a mixed system of ethylene carbonate and other components. In addition, ethylene carbonate is known as a highly polar solvent used in an electrolytic solution or the like, and has a property of easily dissolving a polar substance. Therefore, even in a mixed system of a polar solvent and a nonpolar solvent originally not containing ethylene carbonate, the nonpolar solvent can be separated by extracting the polar solvent with ethylene carbonate, and the ethylene carbonate and the polar solvent can be separated by cooling operation.

Therefore, the component C preferably includes ethylene carbonate, and more preferably is ethylene carbonate.

Hereinafter, details of the component separation system (or the component separation method) according to the present embodiment will be described.

### First Separation Unit (or First Separation Process, the Same Applies Hereinafter)

### (First Embodiment)

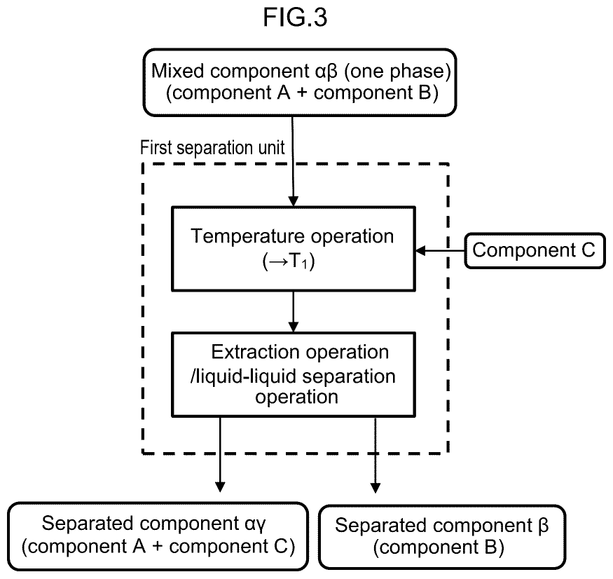

The first separation unit according to the first embodiment is, for example, as illustrated in FIG. 3, a separation unit configured to: add the liquid component C, as an extractant for the component A, to the mixed component αβ, in which the liquid component A and the liquid component B are uniformly mixed, to extraction the component A with the component C; and carry out liquid-liquid separation of the separated component αγ and the separated component β.

In the first separation unit according to the first embodiment, the mixed component αβ is prepared. The ratio of the component A to the component B (component A/component B) in the mixed component αβ is, for example, 10/1 to 1/10 in terms of a mass ratio. The component A and the component B may be mixed while adjusted to a temperature at which the component A and the component B are uniformly mixed to prepare the mixed component αβ.

Next, the component C is added to the mixed component αβ to obtain the mixed component αβγ.

Then, the temperature of the mixed component αβγ is controlled to the temperature T₁. The temperature T₁ is, for example, within a range of 40° C. or higher and the boiling point of each component or lower.

The temperature operation of the mixed component αβγ to the temperature T₁ may be a temperature raising operation of the mixed component αβγ or a cooling operation. In addition, the temperatures of the mixed component αβ and the component C may be adjusted in advance such that the temperature of the mixed component αβγ becomes the temperature T₁ when the component C is added to the mixed component αβ.

In the mixed component αβγ to which the component C is added, the separated component αγ and the separated component β are phase-separated by extraction of the component A with the component C. Then, the separated component αγ and the separated component β are separated by a liquid-liquid separation operation. As the liquid-liquid separation operation, a known method such as a method using a separatory funnel can be employed.

The number of times of the extraction operation and the liquid-liquid separation operation and the addition amount of the component C are determined, for example, from the distribution coefficient of the component A in the mixed component αβγ and the amount of the mixed component αβ.

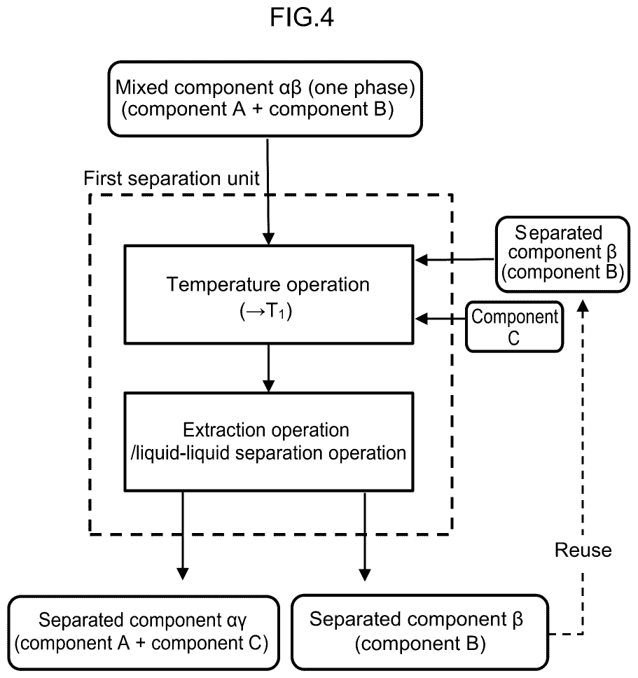

Here, in the first separation unit according to the first embodiment, in a case where the proportion of the component B in the mixed component αβ is small, the influence of the component A becomes dominant, and in the mixed component αβγ, phase separation may hardly occur between the separated component αγ and the separated component. In this case, as illustrated in FIG. 4, the separated component β may be reused, the separated component β may be added to the mixed component αβ in addition, and the proportion of the component B in the mixed component αβ may be increased to be in the above range.

Incidentally, the component B may be separately prepared, and the component B may be additionally added to the mixed component αβ to increase the proportion of the component B in the mixed component αβ.

### (Second Embodiment)

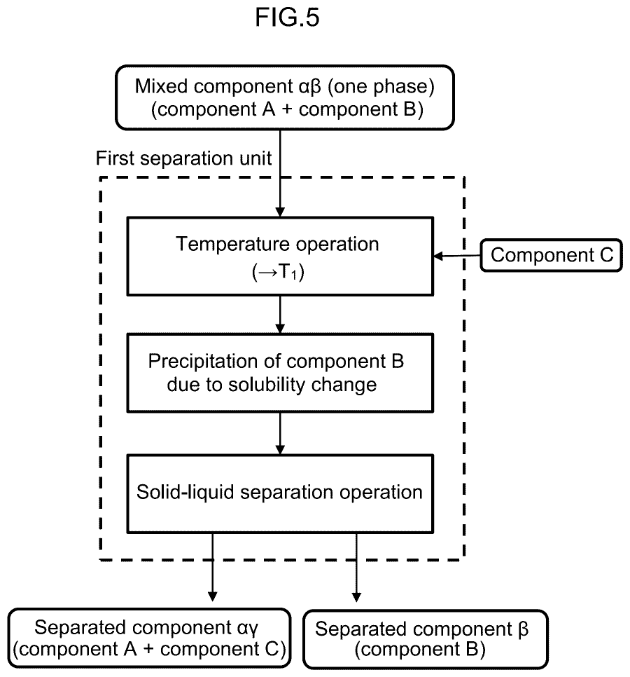

In the first separation unit according to the second embodiment, for example, as illustrated in FIG. 5, the first separation unit is a separation unit configured to: add the liquid component C, which is a poor solvent for the component B, to the mixed component αβ, in which the solid component B is dissolved in the liquid component A that is a good solvent for the component B, to precipitate the component B; and carry out solid-liquid separation of the separated component αγ and the separated component β.

In the first separation unit according to the second embodiment, the mixed component αβ is prepared. The ratio of the component A to the component B (component A/component B) in the mixed component αβ is, for example, 1000/1 to 10/1 in terms of a mass ratio. The mixed component αβ may be prepared by adjusting the temperature so that the component B dissolves in the component A.

Next, the component C is added to the mixed component αβ to obtain the mixed component αβγ.

Then, the temperature of the mixed component αβγ is controlled to the temperature T₁. The range of the temperature T₁ and the method of operating the temperature of the mixed component αβγ to the temperature T₁ are the same as those of the first separation unit according to the first embodiment.

In the mixed component αβγ to which the component C is added, the solubility of the component B changes, and the component B precipitates. Then, the separated component ay and the separated component β are separated by a solid-liquid separation operation. As the solid-liquid separation operation, well-known methods such as filtration, centrifugation, and decantation can be employed.

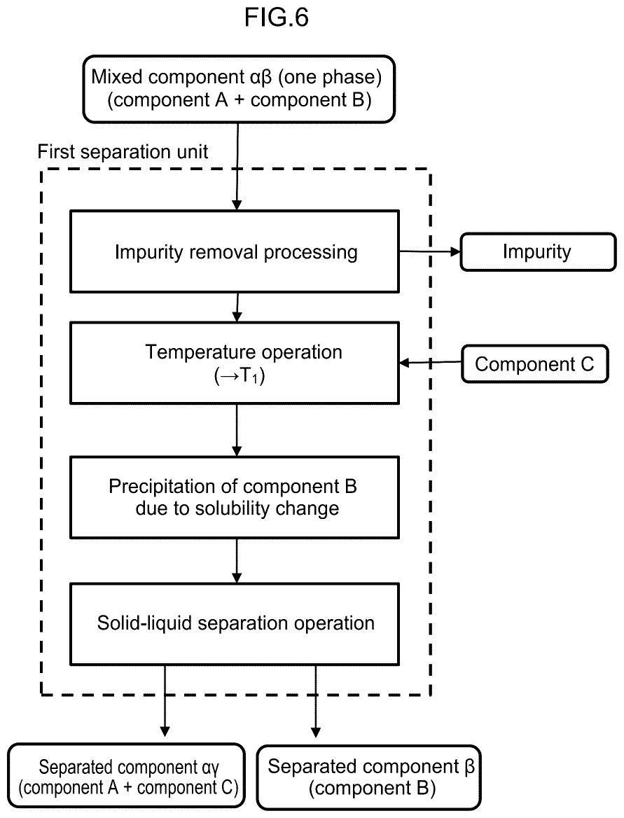

Here, in the first separation unit according to the second embodiment, in a case where impurities are mixed in the mixed component αβ, as illustrated in FIG. 6, before the component C is added to the mixed component αβ, processing for removing impurities may be carried out. As a method for removing the impurities, known methods such as a method using an adsorbent, filtration, centrifugation, and decantation can be employed.

### Second Separation Unit (Second Separation Process, the Same Applies Hereinafter)

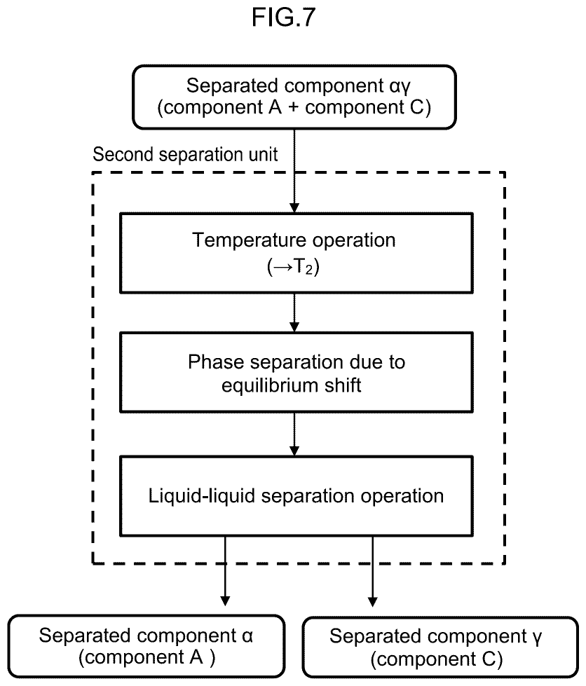

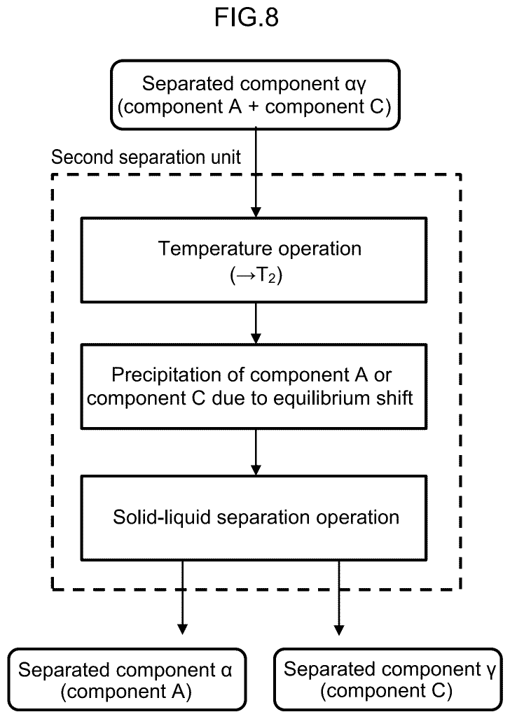

As illustrated in FIGS. 7 and 8, the second separation unit according to the present embodiment is a separation unit configured to change the temperature of the separated component αγ to a temperature T₂ to separate the separated component αγ into the separated component α containing the component A as a main component and the separated component y containing the component C as a main component.

In the second separation unit according to the present embodiment, the temperature of the separated component αγ is controlled to the temperature T₂, but in a case where the component A and the component C exhibit the UCST type separation behavior, the temperature T₂ of the separated component αγ is made lower than the temperature T₁. That is, the temperature T₂ is set to be lower than the temperature T₁ by cooling the separated component αγ so that the relationship of temperature T₁>temperature T₂ is established.

On the other hand, in a case where the component A and the component C exhibit the LCST type separation behavior, the temperature T₂ of the separated component αγ is set higher than the temperature T₁. That is, the temperature T₂ is set to be higher than the temperature T₁ by increasing the temperature of the separated component αγ so that the relationship of temperature T₁<temperature T₂ is established.

Here, the temperature T₂ can be adjusted by the proportion of the component A or the component C, preferably the proportion of the component C in the separated component ay. Therefore, in the first separation unit according to the first and second embodiments described above, it is preferable to adjust the types of the component A and the component C and the addition amount of the component C to achieve the target temperature T₂.

The difference (absolute value) between the temperature T₁ and the temperature T₂is, for example, within a range of 10° C. or higher.

When the temperature of the separated component αγ reaches the temperature T₂ by temperature operation, the separated component α and the separated component γ are phase-separated due to equilibrium shift. Then, the separated component αγ and the separated component γ are separated by a liquid-liquid separation operation (refer to FIG. 7). As the liquid-liquid separation operation, a known method such as a method using a separatory funnel can be employed.

However, when the temperature of the separated component αγ is adjusted to be the temperature T₂ by temperature operation, the component A or the component C precipitates when the temperature T₂ falls below the melting point of the component A or the component C (refer to FIG. 8). In this case, the separated component αγ and the separated component γ are separated by a solid-liquid separation operation. As the solid-liquid separation operation, well-known methods such as filtration, centrifugation, and decantation can be employed.

In addition, the temperature T₂ can be adjusted by the composition of the component A or the component C in the separated component αγ.

By controlling the temperature T₂ by the composition of the component A or the component C in the separated component αγ, the component separation energy can be reduced. For example, in a case where the component A and the component C exhibit the UCST type phase change behavior, it is necessary to satisfy T₁> phase change temperature >T₂. However, by bringing the phase change temperature close to T₁, T₂ can also be increased, and the consumed energy corresponding to the temperature change between T₁ and T₂ can be reduced. In addition, the control of the phase change temperature is also effective in a case where it is desired to set T₁ and T₂ to be equal to or lower than the boiling point and equal to or higher than the freezing point of each component.

In a case where the temperature T₂ is adjusted by the composition of the component A in the separated component αγ, the component A is preferably two or more compounds, more preferably at least two selected from the group consisting of aromatic hydrocarbons, alcohols, halogenated hydrocarbons, amides, and sulfoxides, still more preferably at least two selected from the group consisting of aromatic hydrocarbons and alcohols, and particularly preferably two aromatic hydrocarbons or two alcohols, from the viewpoint of separability and ease of adjustment of T₂.

As the aromatic hydrocarbons when two or more kinds are used as the component A, from the viewpoint of separability and ease of adjustment of T₂, two or more kinds selected from the group consisting of benzene, ethylbenzene, toluene, xylene, mesitylene, cymene, cumene and pseudocumene are preferable, two or more kinds selected from the group consisting of toluene, xylene, mesitylene, cymene and cumene are more preferable, and toluene and xylene are particularly preferable.

As the alcohols in the case of using two or more kinds as the component A, from the viewpoint of separability and ease of adjustment of T₂, two or more kinds of aliphatic alcohols are preferable, two or more kinds selected from the group consisting of methanol, ethanol, propanol, butanol, and hexanol are more preferable, and ethanol and 1-propanol are particularly preferable.

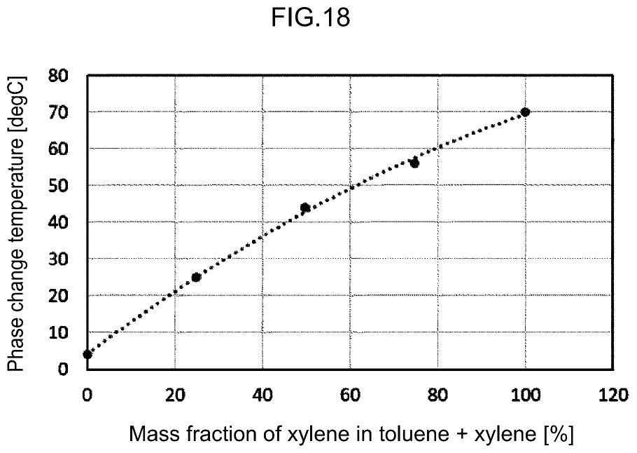

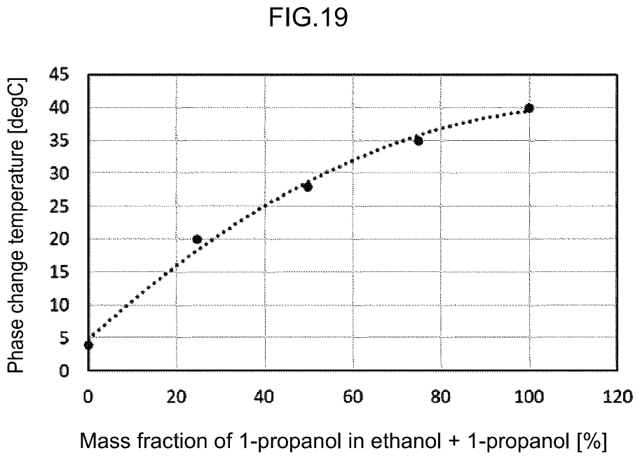

FIGS. 18 and 19 illustrate phase change temperatures in a case where aromatic hydrocarbons and alcohols are used as the component A, ethylene carbonate is used as the component C, and the composition of the component A is changed. The phase change temperature is a value when the mass ratio of the component A to the component C is 1:1. In addition, the mixed solvent of the component A and the component C was stirred while changing the temperature, and the phase change temperature was recorded by observing the change in brightness of the solvent.

First, in the case of aromatic hydrocarbons, a solvent obtained by mixing toluene and xylene was used, and as illustrated in FIG. 18, it was confirmed that the phase change temperature increased as the proportion of xylene increased. Furthermore, the behavior of the phase change temperature can be approximated by a quadratic curve with respect to the proportion of xylene, and it is shown that the phase change temperature can be predicted even in an unmeasured composition.

Subsequently, in the case of alcohols, a solvent obtained by mixing ethanol and 1-propanol was used, and as illustrated in FIG. 19, it was confirmed that the phase change temperature increases as the proportion of 1-propanol increases, and the result that the behavior of the phase change temperature can be approximated by a quadratic curve with respect to the proportion of 1-propanol as in the case of aromatic hydrocarbons was obtained. By applying these results and adjusting the composition of the component A, the phase change temperature can be controlled. In this example, a combination of toluene and xylene and a combination of ethanol and 1-propanol have been described, but it is also possible to control the phase change temperature in a wider range by using substances of other aromatic hydrocarbons and alcohols.

In a case where the temperature T₂ is adjusted by the composition of the component C in the separated component αγ, the component C is preferably two or more compounds, more preferably ethylene carbonate and at least one selected from the group consisting of cyclic carbonates, other than ethylene carbonate, and polyhydric alcohols, and particularly preferably ethylene carbonate and at least one selected from the group consisting of propylene carbonate and ethylene glycol, from the viewpoint of separability and ease of adjustment of T₂.

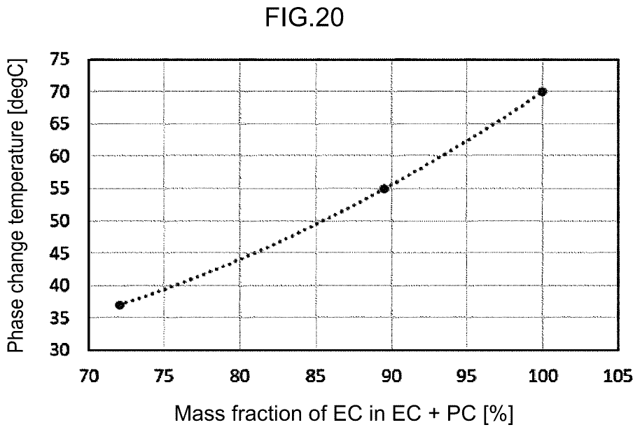

The phase change temperature in a case where xylene or p-cymene is used as the component A, a mixed solvent of ethylene carbonate (EC) and propylene carbonate (PC) or a mixed solvent of ethylene carbonate and ethylene glycol (EG) is used as the component C, and the composition of the component C is changed is illustrated in FIGS. 20 to 22. The phase change temperature is a value when the mass ratio of the component A to the component C is 1:1. In addition, the mixed solvent of the component A and the component C was stirred while changing the temperature, and the phase change temperature was recorded by observing the change in brightness of the solvent.

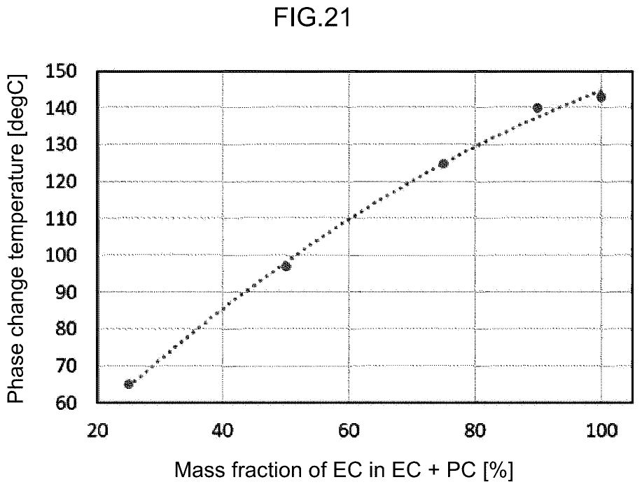

First, in the case of using a mixed solvent of ethylene carbonate and propylene carbonate, it has been confirmed that the phase change temperature increases as the proportion of ethylene carbonate increases as illustrated in FIGS. 20 and 21. This is because propylene carbonate is a solvent that is miscible with xylene and p-cymene, and separation becomes difficult due to a decrease in the proportion of propylene carbonate.

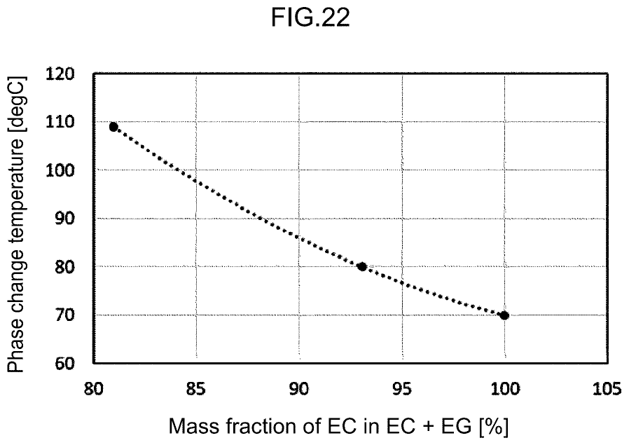

Subsequently, in the case where a mixed solvent of ethylene carbonate and ethylene glycol was used, it was confirmed, as illustrated in FIG. 22, that the phase change temperature decreases as the proportion of ethylene carbonate increases. This is because ethylene glycol is a solvent that is separative from xylene, and the separation becomes easy as the proportion of ethylene glycol decreases.

By applying these results and adjusting the composition of the component C, the phase change temperature can be controlled. In this example, the combination of ethylene carbonate and propylene carbonate and the combination of ethylene carbonate and ethylene glycol have been described. However, by selecting an appropriate substance according to the phase equilibrium behavior with the component A, the phase change temperature can be controlled in a wider range. It can also be combined with the composition adjustment of component A.

### Other Aspects

### (First Embodiment)

The component separation system having the first separation unit according to the first embodiment can be applied to a solid substance purification system (hereinafter, the “purification system of a solid substance according to the first embodiment”).

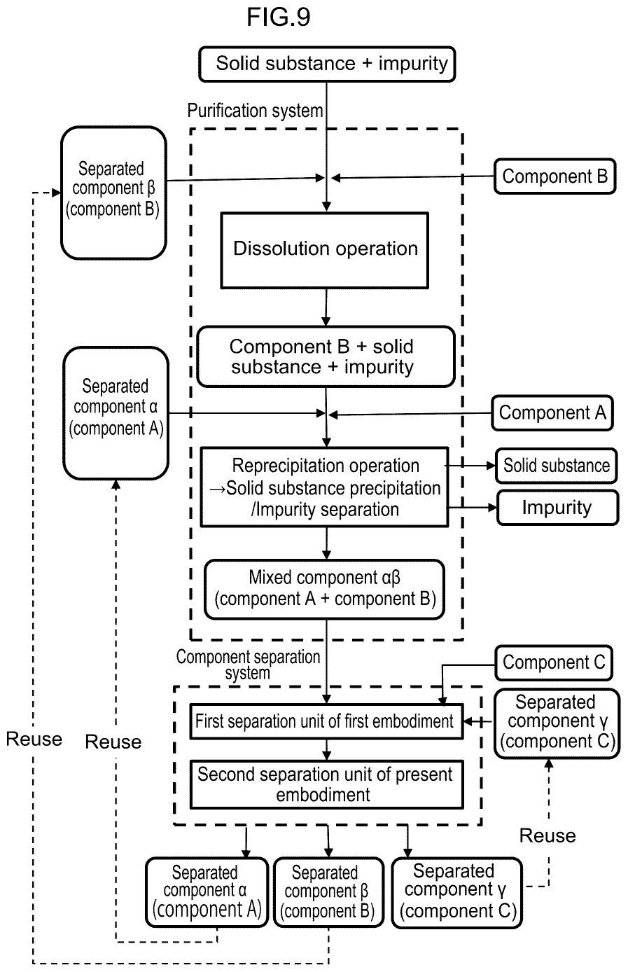

In the purification system of the solid substance according to the first embodiment, as illustrated in FIG. 9, a solid substance mixed with impurities is subjected to a dissolution operation by adding the liquid component B, which serves as a good solvent for the solid substance, to dissolve the solid substance into the component B. Thereby, a solution containing the component B, the solid substance, and the impurities is obtained.

Next, the component A as a poor solvent for the solid substance is added to the solution, and the solid substance is precipitated by a reprecipitation operation to separate the solid substance and impurities. In other words, in the component separation system having the first separation unit according to the first embodiment, the mixed component αβ corresponds to a mixed system after reprecipitation of the solid substance, and is a mixed component in which the component A as a poor solvent for the solid substance and the component B as a good solvent for the solid substance are uniformly mixed.

Then, separation is carried out by the component separation system including the first separation unit according to the first embodiment using the remaining mixed component αβ containing the component A and the component B as a main component.

Accordingly, in the purification system of the solid substance according to the first embodiment, each component can be separated together with the purification of the solid substance.

In the purification system of the solid substance according to the first embodiment (and the component separation system having the first separation unit according to the first embodiment), a preferable example is a combination in which the solid substance is a resin (particularly, a styrene resin), the component A is an alcohol, the component B is a terpene, and the component C is ethylene carbonate.

In the purification system of the solid substance according to the first embodiment (and the component separation system including the first separation unit according to the first embodiment), the separated components α, β, and γ can each be reused.

### (Second Embodiment)

The component separation system having the first separation unit according to the second embodiment can be applied to a solid substance purification system (hereinafter, the “purification system of a solid substance according to the second embodiment”).

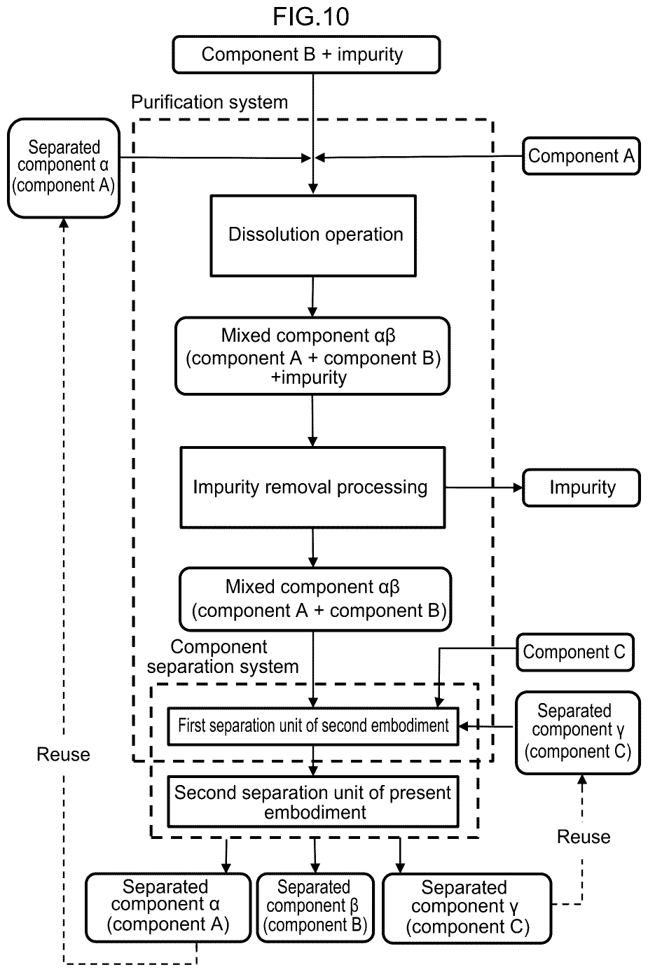

In the purification system of the solid substance according to the second embodiment, as illustrated in FIG. 10, the solid component B mixed with impurities is subjected to a dissolution operation by adding the liquid component A, which serves as a good solvent for the solid substance, to dissolve component B into the component A. As a result, the component B is dissolved in the component A to obtain the mixed component αγ containing impurities.

Next, impurity removal processing is carried out on the mixed component αγ to remove impurities.

Then, separation is carried out by the component separation system including the first separation unit according to the second embodiment using the remaining mixed component αβ containing the component A and the component B.

Accordingly, in the purification system of the solid substance according to the second embodiment, each component can be separated together with the purification of the solid component B.

In the purification system of the solid substance according to the second embodiment (and the component separation system including the first separation unit of the second embodiment), a preferred example is a combination in which the component A is an aromatic hydrocarbon, the component B is a resin (particularly a polyolefin resin), and the component C is ethylene carbonate.

In the purification system of the solid substance according to the second embodiment (and the component separation system including the first separation unit according to the second embodiment), the separated components α and γ can each be reused.

### EXAMPLES

Hereinafter, the disclosure will be described in more detail with reference to examples, but the disclosure is not limited to these examples. In addition, examples were carried out under normal pressure.

### Example 1: Reprecipitation of Polystyrene Resin and Component Separation

An example in which the component separation system of the disclosure is applied to a polystyrene resin purification system will be described.

First, 300 mg of a polystyrene resin was completely dissolved in 15 g of d-limonene (an example of the component B) as a good solvent at room temperature to obtain a polystyrene resin solution.

Next, 15 g of ethanol (an example of the component A) as a poor solvent was added to the polystyrene resin solution, and the solution was well stirred to precipitate a polystyrene resin.

Next, a polystyrene resin precipitate was separated from the polystyrene resin solution by centrifugation. To a remaining mixed solvent αβ (an example of mixed component αβ) containing d-limonene and ethanol at a mass ratio of 1:1, 12 g of ethylene carbonate (an example of the component C) liquefied by heating at 40° C. was added, and the mixture was well shaken to obtain a mixed solvent αβγ (an example of the mixed component αβγ).

Then, the temperature of the mixed solvent αβγ became a temperature T₁=40° C., and the phase was separated into the upper layer liquid and the lower layer liquid. A liquid-liquid separation operation of separating the upper layer liquid and the lower layer liquid was carried out using a separatory funnel, 12 g of ethylene carbonate was added again to the remaining upper layer liquid and lower layer liquid, and after stirring, the liquid-liquid separation operation was carried out on the upper layer liquid and the lower layer liquid using a separatory funnel. The same operation was repeated twice more. The temperature of the liquid during the operation was set to a temperature T₁=40°C.

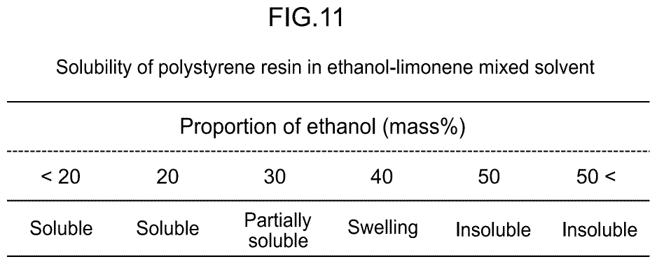

The upper layer liquid after the extraction operation was a separated solvent β (an example of the separated component B) containing ethylene carbonate, ethanol, and d-limonene at a mass ratio of 3.5:15.6:80.9 and having d-limonene as a main component. The separated solvent β contains 15.6 mass % of ethanol, but in a case where the proportion of the ethanol is 20 mass % or less as illustrated in FIG. 11, the mixed solvent of d-limonene and ethanol is considered to act as a good solvent for the polystyrene resin. When 300 mg of the polystyrene resin was actually added to the separated solventβ, the polystyrene resin was completely dissolved, and it was shown that the separated solvent β recovered by this series of operations can be reused for the reprecipitation operation of the polystyrene resin.

On the other hand, the lower layer liquid after the extraction operation was a separated solvent αγ (an example of the separated component αγ) containing ethylene carbonate, ethanol, and d-limonene in a mass ratio of 62.2:34.5:3.3.

Next, the separated solvent αγ was allowed to stand at 4° C. for 15 minutes and cooled, and when the temperature of the separated solvent αγ reached a temperature T₂=4° C., a precipitate γ of the component C (an example of the separated component γ) was precipitated on the bottom of the container. Then, the separated solvent α and the precipitate y of the component C were solid-liquid separated by filtration and centrifugation.

The separated solvent α was a liquid mainly composed of ethanol, containing ethylene carbonate, ethanol, and d-limonene in a mass ratio of 7.8:58.7:33.5. The separated solvent α was recovered in a state of being reusable as a poor solvent in the reprecipitation operation of the polystyrene resin.

Subsequently, in the reprecipitation operation of the polystyrene resin, the consumed energy per 1 kg of the polystyrene resin for component separation including solvent recovery after reprecipitation was calculated. In this calculation, the calculation was carried out assuming that d-limonene and ethanol were used at a mass ratio of 50 times and ethylene carbonate was used at a mass ratio of 150 times with respect to the polystyrene resin, the thermal efficiency of each operation was 25%, and the separation operation efficiency was 100%. In addition, for thermophysical properties of each component, the values described in the data book of NIST were referred to.

In this calculation, the specific heat and the heat of dissolution of the polystyrene resin and the heat of uniform mixing of the solvents are not taken into consideration.

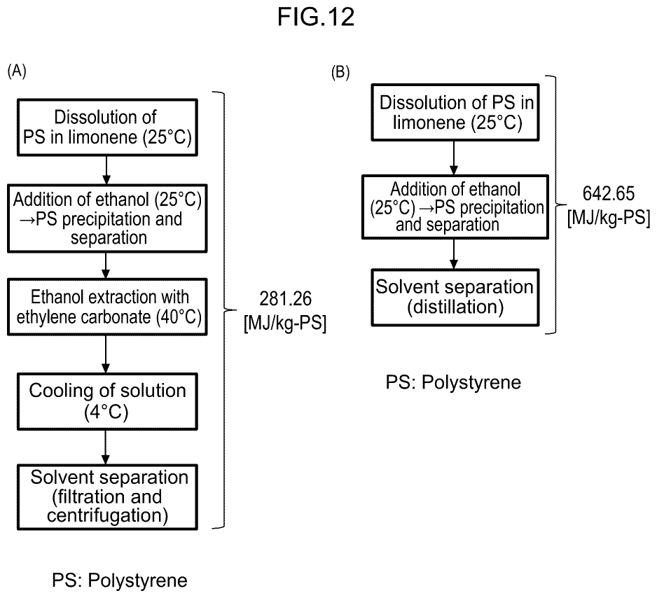

The calculation results are illustrated in FIG. 12. FIG. 12(A) illustrates a calculation result of the component separation system of Example 1, and FIG. 12(A) illustrates a result of the component separation system according to a conventional distillation method.

The calculation results that while the consumed energy according to the conventional method was about 643 [MJ/kg-PS], the consumed energy was reduced to about 281 [MJ/kg-PS] using the component separation system of Example 1 were obtained.

Here, the conventional method was regarded as a system in which 1) a polystyrene resin (PS) is dissolved in d-limonene at 25° C., 2) ethanol is added to a polystyrene resin solution to precipitate and separate the polystyrene resin, and 3) d-limonene and ethanol are separated by distillation.

### Example 2: Reprecipitation of Polypropylene Resin and Component Separation

An example in which the component separation system of the disclosure is applied to a purification system of a polypropylene resin (an example of the component B) will be described.

300 mg of the polypropylene resin (an example of the component B) was completely dissolved in 15 g of xylene (an example of the component A) as a good solvent at 130° C. to obtain a polypropylene resin solution αβ (an example of the mixed component αβ). Next, to the polypropylene resin solution αβ, 15 g of ethylene carbonate (an example of the component C) liquefied by heating at 40° C. was added, and the mixture was well stirred to obtain a mixed solution αβγ (an example of the mixed component αβγ) at a temperature T₁=88° C., and the precipitate β of the polypropylene resin (an example of the separated component β) was precipitated. The precipitate β of the polypropylene resin was precipitated at the moment when ethylene carbonate was added to the polypropylene resin solution αβ.

Then, the precipitate β of the polypropylene resin was recovered by filtration.

Next, the remaining mixed solvent αγ (an example of the separated component αγ) containing xylene and ethylene carbonate at a mass ratio of 1:1 was left at room temperature. Separation gradually occurred when the temperature of the mixed solvent αγ reached 70° C. or lower, and a clear liquid-liquid interface occurred when the temperature T₂ reached 40° C. or lower, so that phase separation occurred between the upper layer liquid and the lower layer liquid.

Next, the liquid-liquid separation operation of separating the upper layer liquid and the lower layer liquid using a separatory funnel was carried out.

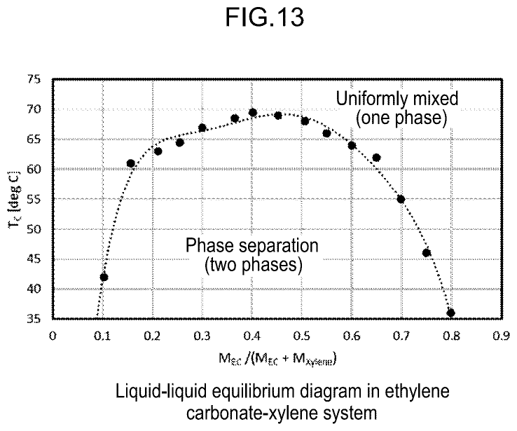

From the liquid-liquid equilibrium state diagram of the ethylene carbonate-xylene system illustrated in FIG. 13, it is estimated that the upper layer liquid is the separated solvent a (an example of the separated component α) containing xylene as a main component and about 10 mass % of ethylene carbonate, and the lower layer liquid is the separated solvent γ (an example of the separated component γ) containing ethylene carbonate as a main component and about 20 mass % of xylene.

In FIG. 13, M_{EC} represents the mass of ethylene carbonate, M_{xylene} represents the mass of xylene, and Tc represents the temperature of the system.

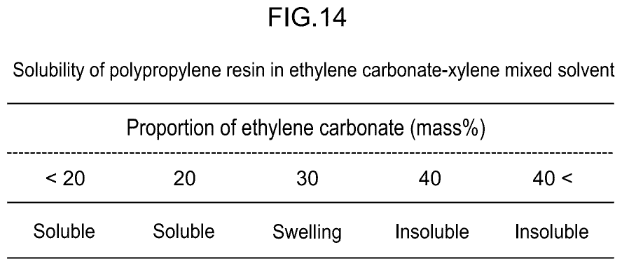

Here, as illustrated in FIG. 14, in a case where the proportion of the ethylene carbonate is 20 mass % or less, since the mixed solvent of the ethylene carbonate and the xylene acts as a good solvent for polypropylene, it can be considered that the separated solvent α can be reused as a good solvent for the polypropylene resin.

Next, similarly to the case of Example 1, the consumed energy was calculated also in the reprecipitation operation of the polypropylene resin. In this calculation, it was regarded that the xylene and the ethylene carbonate were used at a mass ratio of 50 times with respect to the polypropylene resin, and the other conditions were the same as those in Example 1.

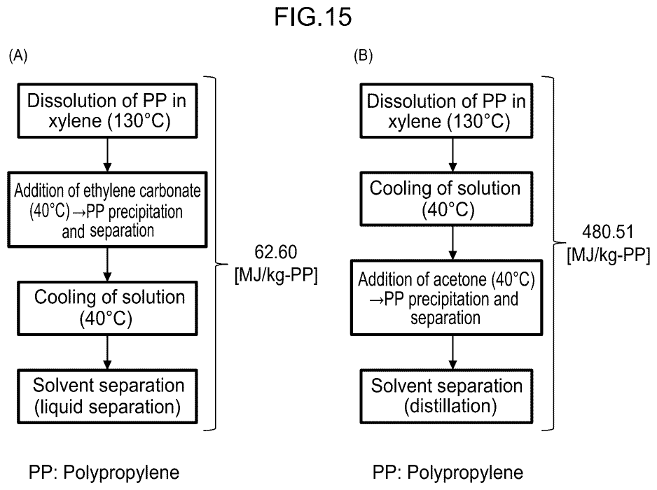

The calculation results are illustrated in FIG. 15. FIG. 15(A) illustrates a calculation result of the component separation system of Example 2, and FIG. 15(B) illustrates a result of the component separation system according to a conventional distillation method.

The calculation results that while the consumed energy according to the conventional method was about 480 [MJ/kg-PP], the consumed energy was reduced to about 63 [MJ/kg-PP] using the component separation system of Example 2 were obtained.

Here, the conventional method was regarded as a system in which 1) a polypropylene resin (PP) is dissolved in xylene at 130° C., 2) a polypropylene resin solution is cooled to 40° C., 3) acetone at 40° C. is added to the polypropylene resin solution to precipitate and separate the polypropylene resin, and 3) xylene and acetone are separated by distillation.

### Example 3: Reprecipitation of Polyethylene Resin and Component Separation

An example in which the component separation system of the disclosure is applied to a purification system of a polyethylene resin (an example of the component B) will be described.

300 mg of the polyethylene resin (an example of the component B) was completely dissolved in 15 g of xylene (an example of the component A) at 115° C. to obtain the polyethylene resin solution αβ (an example of the mixed component αβ).

Next, to the polyethylene resin solution αβ, 15 g of ethylene carbonate (an example of the component C) liquefied by heating at 40° C. was added, and the mixture was well stirred to obtain the mixed solution αβγ (an example of the mixed component αβγ) at a temperature T₁=80° C., and the precipitate β of the polyethylene resin (an example of the separated component β) was precipitated. The precipitate β of the polyethylene resin was precipitated at the moment when ethylene carbonate was added to the polyethylene resin solution αβ.

Then, the precipitate β of the polyethylene resin was recovered by filtration.

The remaining mixed solvent αγ (an example of the separated component αγ) containing xylene and ethylene carbonate at a mass ratio of 1:1 was left at room temperature. Separation gradually occurred when the temperature of the mixed solvent αγ reached 70° C. or lower, and a clear liquid-liquid interface occurred when the temperature T₂ reached 40° C. or lower, so that phase separation occurred between the upper layer liquid and the lower layer liquid.

Next, the liquid-liquid separation operation of separating the upper layer liquid and the lower layer liquid using a separatory funnel was carried out.

From the liquid-liquid equilibrium state diagram of ethylene carbonate-xylene illustrated in FIG. 13, it is estimated that the upper layer liquid is the separated solvent α (an example of the separated component α) containing xylene as a main component and about 10 mass % of ethylene carbonate, and the lower layer liquid is the separated solvent (an example of the separated component γ) containing ethylene carbonate as a main component and about 20 mass % of xylene.

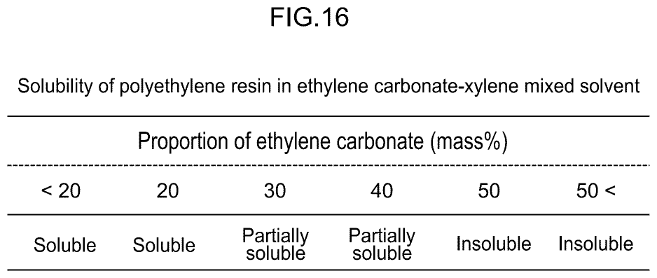

Here, as illustrated in FIG. 16, in a case where the proportion of the ethylene carbonate is 20 mass % or less, since the mixed solvent of the ethylene carbonate and the xylene acts as a good solvent for the polypropylene resin, it can be considered that the separated solvent α can be reused as a good solvent for the polyethylene resin.

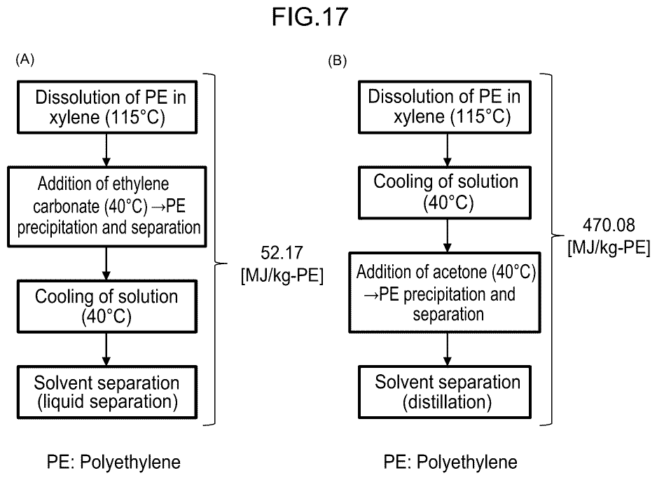

Next, similarly to the case of Example 2, the consumed energy in the reprecipitation operation of the polyethylene resin was calculated. The calculation conditions were exactly the same as in Example 2. The calculation results are illustrated in FIG. 17. FIG. 17(A) illustrates a calculation result of the component separation system of Example 3, and FIG. 17(B) illustrates a result of the component separation system according to a conventional distillation method.

The calculation results that while the consumed energy according to the conventional method was about 470 [MJ/kg-PE], the consumed energy was reduced to about 52 [MJ/kg-PE] using the component separation system of Example 3 were obtained.

Here, the conventional method was regarded as a system in which 1) the polyethylene resin (PP) is dissolved in xylene at 115° C., 2) the polyethylene resin solution is cooled to 40° C., 3) acetone at 40° C. is added to the ethylene resin solution to precipitate and separate the polyethylene resin, and 3) xylene and acetone are separated by distillation.

### Example 4: Reprecipitation Operation of Polypropylene

300 mg of the polypropylene were completely dissolved in 15 g of the xylene at 130° C. When 13 g of ethylene carbonate and 3 g of ethylene glycol were added to this polypropylene solution and stirred well, the polypropylene was precipitated. This polypropylene precipitate was recovered by filtration, and the remaining mixed solution of the xylene, the ethylene carbonate, and the ethylene glycol was left to stand until the temperature reached 80° C., and a clear liquid-liquid interface was generated. This solution was separated into an upper layer liquid and a lower layer liquid using a separatory funnel. When 300 mg of new polypropylene was completely dissolved in the recovered upper layer liquid at 130° C., this polypropylene solution was added to the recovered lower layer liquid, and the mixture was well stirred, the polypropylene was precipitated. In the same manner as in the first operation, a polypropylene precipitate was recovered by filtration, and the remaining mixed solvent was left to stand until the temperature reached 80° C., and a clear liquid-liquid interface was generated. This solution was separated into an upper layer liquid and a lower layer liquid using a separatory funnel. As a result, it was confirmed that the solvent system used in this test can be repeatedly used by being separated by phase change. The yield of the polypropylene precipitate recovered in the first and second operations was 90% or more.

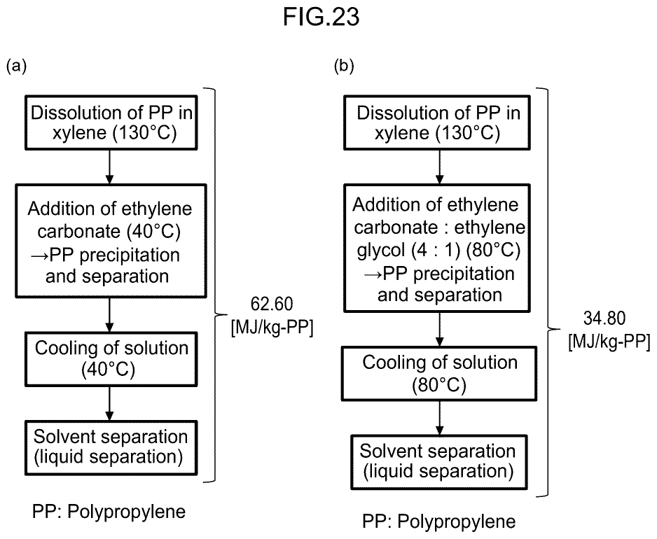

Subsequently, in the reprecipitation operation of the polypropylene of Example 2 and Example 4, the consumed energy per 1 kg of the polypropylene in the process including solvent recovery after reprecipitation was calculated. In the present calculation, the calculation was carried out assuming that a mixed solvent containing xylene and ethylene carbonate and ethylene glycol at a proportion of 4:1 (mass ratio) was used 50 times the mass ratio of polypropylene, the thermal efficiency of each operation was 25%, and the separation operation efficiency was 100%. In addition, for thermophysical properties of each substance, the values described in the data book of NIST were referred to. This calculation does not take into account the specific heat or heat of dissolution of polypropylene, nor the heat of uniform mixing of the solvents. The calculation results are illustrated in FIG. 23. FIG. 23(a) illustrates a calculation result of a case of Example 2, and FIG. 23(b) illustrates a result of a case of Example 4. This time, the calculation results were obtained that while the consumed energy in Example 2 was about 63 [MJ/kg-PP], the consumed energy in Example 4 was reduced to about 35 [MJ/kg-PP].

From the above, it can be understood that the component separation system of the present example is capable of separating components under normal pressure without using distillation and with energy saving.

In addition, it can be understood that the component separation system of the present example can carry out component separation together with purification of solid substance.

The disclosures of Japanese Patent Application No. 2023-015498, filed Feb. 3, 2023, and Japanese Patent Application No. 2023-184258, filed Oct. 26, 2023, are incorporated herein by reference in their entirety.

All publications, patent applications, and technical standards mentioned in this specification are herein incorporated by reference to the same extent as if each individual publication, patent application, or technical standard was specifically and individually indicated to be incorporated by reference.

1. A component separation system, comprising:
a first separation unit configured to: add a component C to a one-phase mixed component αβ containing a component A and a component B; and separate a mixed component αβγ containing the component A, the component B, and the component C, at a temperature T₁, into a separated component αγ containing the component A and the component C as a main component and a separated component β containing the component B as a main component; and
a second separation unit configured to change a temperature of the separated component αγ to a temperature T₂ to separate the separated component αγ into a separated component α containing the component A as a main component and a separated component γ containing the component C as a main component,
wherein the component C exhibits a miscible behavior with respect to the component A at the temperature T₁ of the mixed component αβγ, exhibits a separation behavior with respect to the component B at the temperature T₁ of the mixed component αβγ, and exhibits a separation behavior with respect to the component A at the temperature T₂ of the separated component αγ.

2. The component separation system according to claim 1, wherein the first separation unit is a separation unit configured to: add the component C, as an extractant for the component A, to the mixed component αβ, in which the component A in a liquid state and the component B in a liquid state are uniformly mixed, to extract the component A with the component C; and carry out liquid-liquid separation of the separated component αγ and the separated component β.

3. The component separation system according to claim 2, wherein the mixed component αβ is a mixed system after reprecipitation of a solid substance, and is a mixed component in which the component A as a poor solvent for the solid substance and the component B as a good solvent for the solid substance are uniformly mixed.

4. The component separation system according to claim 3, wherein:
the solid substance is a styrene resin,
the component A is an alcohol,
the component B is a terpene, and
the component C is ethylene carbonate.

5. The component separation system according to claim 1, wherein the first separation unit is a separation unit configured to: add the component C in a liquid state, as a poor solvent for the component B, to the mixed component αβ, in which the component B in a solid state is dissolved in the component A in a liquid state that is a good solvent for the component B, to precipitate the component B; and carry out solid-liquid separation of the separated component αγ and the separated component β.

6. The component separation system according to claim 5, wherein:
the component A is an aromatic hydrocarbon,
the component B is a polyolefin resin, and
the component C is ethylene carbonate.

7. The component separation system according to claim 5, wherein the temperature T₂ is adjusted based on a proportion of the component A or the component C in the separated component αγ.

8. The component separation system according to claim 5, wherein the temperature T₂ is adjusted based on a composition of the component A or the component C in the separated component αγ.

9. The component separation system according to claim 8, wherein:
the component A is at least one selected from the group consisting of aromatic hydrocarbons and alcohols,
the component B is a polyolefin resin, and
the component C contains ethylene carbonate.

10. The component separation system according to claim 9, wherein the component A is two aromatic hydrocarbons or two alcohols.

11. The component separation system according to claim 9, wherein the component C is ethylene carbonate and at least one selected from the group consisting of cyclic carbonates, other than ethylene carbonate, and polyhydric alcohols.
